(19) United States
(12) Patent Application Publication
(10) Pub. No.: US 2026/0331559 A1
(43) Pub. Date: Oct. 22, 2026

(54) RECHARGEABLE BATTERY

(71) Applicant: TOYOTA BATTERY CO., LTD., Kosai-shi (JP)

(72) Inventor: Yuji KATAYAMA, Okazaki-shi (JP)

(73) Assignee: TOYOTA BATTERY CO., LTD., Kosai-shi (JP)

(21) Appl. No.: 19/468,137

(22) Filed: Feb. 3, 2026

(30) Foreign Application Priority Data
Mar. 21, 2025 (JP) 2025-046635

(51) Int. Cl. H01M 10/04; A62C 3/16; H01M 10/0525; H01M 50/103; H01M 50/112; H01M 50/131

(52) U.S. Cl. CPC H01M 10/0468; A62C 3/16; H01M 10/0525; H01M 50/103; H01M 50/112; H01M 50/131

(57) ABSTRACT

A rechargeable battery includes a cell case, an electrode body, and an elastic member. The cell case has two opposing side walls. The electrode body is accommodated in the cell case and is disposed between the two opposing side walls. The electrode body is formed by stacking a cathode plate and an anode plate with a separator arranged in between and rolling the stack. The elastic member is disposed between the electrode body and at least one of the two opposing side walls. The elastic member includes a close-contact portion and projections. The close-contact portion is in close contact with the electrode body. The projections project from the close-contact portion toward the at least one of the two opposing side walls. The projections are each tapered.

### CROSS-REFERENCE TO RELATED APPLICATIONS

This application is based upon and claims the benefit of priority from Japanese Patent Application No.2025-046635, filed on Mar. 21, 2025, the entire contents of which are incorporated herein by reference.

### BACKGROUND

### 1. Field

The following description relates to a rechargeable battery, and more particularly, to a rechargeable battery including battery cells that do not require stacking.

### 2. Description of Related Art

In rechargeable batteries for driving battery electric vehicles or hybrid electric vehicles, a large number of battery cells are combined to obtain a high voltage. In this case, in order to suppress expansion and contraction of the battery cells, a battery module is formed by stacking flat rechargeable battery cells and restraining the stack with a restraining tool or the like. Then, the battery module is accommodated in a case to be mounted on a vehicle as a battery pack.

Such a battery module requires the additional part of the restraining tool or the like. This may cause a reduction in the energy density of the battery pack, an increase in the weight of the battery pack, or a rise in the manufacturing cost.

In this respect, a “Cell-to-Pack” technique is suggested to use the battery cells directly as battery packs. JP2024-111475A describes an example of a power storage device shown in FIG. 17. This power storage device includes a box-shaped case 110 and an electrode body 150. The case 110 includes a first primary wall 111 and a second primary

wall 112. The power storage device is configured to elastically compress an electrode-stacked portion 150e of the electrode body 150 between the first primary wall 111 and the second primary wall 112 in a thickness-wise direction FH of the electrode body 150 using a corrugated elastic plate of an interposed member 140. Such a configuration allows multiple battery cells to be combined into a battery pack without external restraints.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technique disclosed in JP2024-111475A may not tolerate various degrees of expansion and contraction of a battery cell.

In one general aspect, a rechargeable battery includes a cell case, an electrode body, and an elastic member. The cell case has two opposing side walls. The electrode body is accommodated in the cell case and is disposed between the two opposing side walls. The electrode body is formed by stacking a cathode plate and an anode plate with a separator arranged in between and rolling the stack. The elastic member is disposed between the electrode body and at least one of the two opposing side walls. The elastic member includes a close-contact portion and projections. The close-contact portion is in close contact with the electrode body. The projections project from the close-contact portion toward the at least one of the two opposing side walls. The projections are each tapered.

In the rechargeable battery, the projections may be arranged on the close-contact portion.

In the rechargeable battery, the projections may be arranged in a matrix pattern extending in a lateral direction and a longitudinal direction. The lateral direction is orthogonal to a projecting direction of the projections. The longitudinal direction is orthogonal to both the projecting direction and the lateral direction.

In the rechargeable battery, the projections may each have a shape of a truncated quadrilateral pyramid.

In the rechargeable battery, the projections may each have a shape of a truncated circular cone.

In the rechargeable battery, the projections may include at least one projection arranged at an end part of the close-contact portion in the lateral direction and at least one projection arranged at a central part of the close-contact portion in the lateral direction. A height of the at least one projection arranged at the end part of the close-contact portion in the lateral direction is greater than a height of the at least one projection arranged at the central part of the close-contact portion in the lateral direction.

In the rechargeable battery, the projections may include at least one projection arranged at an end part of the close-contact portion in the lateral direction and at least one projection arranged at a central part of the close-contact portion in the lateral direction. A cross-sectional area of the at least one projection arranged at the end part of the close-contact portion in the lateral direction is greater than a cross-sectional area of the at least one projection arranged at the central part of the close-contact portion in the lateral direction.

In the rechargeable battery, a change ratio of a spring constant (N/mm) of the elastic member, compressed in a thickness-wise direction, relative to a compression ratio (%) of the elastic member in an initial state may decrease when the compression ratio (%) becomes greater than a predetermined value.

In the rechargeable battery, the elastic member may be porous.

In the rechargeable battery, the close-contact portion of the porous elastic member may include an extension extending to a position where an electrolyte solution collects by gravity.

In the rechargeable battery, the elastic member may include two elastic members respectively disposed on two opposite side surfaces of the electrode body. One of the two elastic members does not include the projections.

In the rechargeable battery, the cell case may have a shape of a flat box, and the electrode body may be flattened.

In the rechargeable battery, the rechargeable battery may be a non-aqueous electrolyte rechargeable battery.

In the rechargeable battery, the rechargeable battery may be a lithium-ion rechargeable battery.

In the rechargeable battery, the elastic member may contain capsules of a fire-prevention agent.

Other features and aspects will be apparent from the following detailed description, the drawings, and the claims.

### BRIEF DESCRIPTION OF THE DRAWINGS

FIG. 1 is a perspective view of a battery cell in accordance with a first embodiment.

FIG. 2 is a schematic diagram showing the structure of the battery cell in accordance with the first embodiment, by separating a lid and elastic members.

FIG. 3 is an exploded perspective view of the battery cell in accordance with the first embodiment.

FIG. 4 is a cross-sectional view taken along line IV-IV shown in FIG. 1.

FIG. 5A is a cross-sectional view of the battery cell taken along line V-V shown in FIG. 1, in a state in which an electrode body is in an initial state.

FIG. 5B is a cross-sectional view of the battery cell taken along line V-V shown in FIG. 1, in a state in which the electrode body is expanded.

FIG. 6 is a graph illustrating a ratio of a spring constant (N/mm) to a compression ratio (%) of the elastic member in accordance with the first embodiment and a comparative elastic member having a uniform thickness.

FIG. 7 is a schematic diagram illustrating transfer of a pressure through a projection in accordance with the first embodiment and a comparative projection having a uniform cross-sectional area.

FIG. 8 is a perspective view of the elastic member in accordance with the first embodiment.

FIG. 9 is a plan view of the elastic member in accordance with the first embodiment.

FIG. 10 is a cross-sectional view taken along line X-X shown in FIG. 9.

FIG. 11 is a plan view of an elastic member in accordance with a second embodiment.

FIG. 12A is a plan view of a roll of an electrode body in an expanded state.

FIG. 12B is a front view of the roll of the electrode body in the expanded state, as viewed in a longitudinal direction Y.

FIG. 13 is a plan view of an elastic member in accordance with a third embodiment.

FIG. 14 is a front view of the elastic member in accordance with the third embodiment.

FIG. 15 is a front view of the elastic member shown in FIG. 14, in a state in which an electrode body is expanded from the state shown in FIG. 14.

FIG. 16 is a cross-sectional view of an elastic member in accordance with a fourth embodiment, taken along line IV-IV shown in FIG. 1.

FIG. 17 is a cross-sectional view of a conventional battery cell.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Overview of the First Embodiment

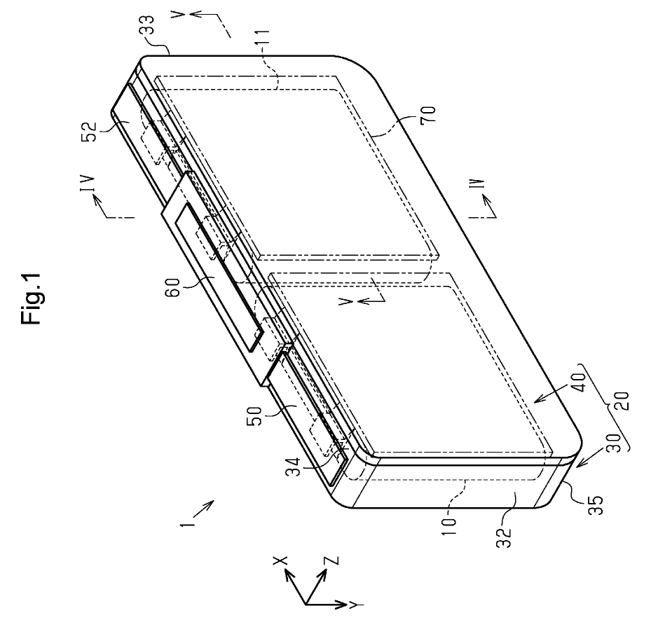

FIG. 1 is a perspective view of a battery cell 1 in accordance with a first embodiment. The first embodiment of the present disclosure is applicable to a “Cell-to-Pack” (CTP) design described in the BACKGROUND section above. The CTP design allows the battery cell 1 of a rechargeable battery to be used directly as a battery pack. In such a CTP design, a battery module is not being formed using a restraining tool.

Accordingly, when an electrode body 10, 11 contracts, the battery cell 1 compresses the electrode body 10, 11 to avoid formation of unnecessary gaps between a cathode plate, an anode plate, and a separator. Also, when the electrode body 10, 11 expands, the battery cell 1 avoids damages to a cell case 20 by restricting generation of an excessively large stress.

One of the purposes of employing the CTP design is to increase volumetric capacity (Ah/m³) of the battery cell 1. Therefore, it would be contrary to the purpose if the battery cell 1 is enlarged to improve the strength of the cell case 20.

The battery cell 1 in accordance with the first embodiment includes an elastic member 70 having a distinctive shape that solves the above-described problem, and thus the battery cell 1 sufficiently tolerates various degrees of expansion and contraction.

### Configuration of the First Embodiment

The battery cell 1 of a lithium-ion rechargeable battery in accordance with the present disclosure will now be described with reference to FIGS. 1 to 17. It should be understood that the present disclosure is not limited to the embodiments described below.

First, the battery cell 1 of a lithium-ion rechargeable battery in accordance with the first embodiment will be described.

In the following description and the accompanying drawings, the present disclosure may be partially omitted, simplified, or schematically illustrated, for the sake of clarity. Same reference numerals are given to same elements in the drawings, and such elements may be described only once.

### Battery Cell 1

The battery cell 1 may be used in any orientation. In the first embodiment, the battery cell 1 is oriented as shown in FIG. 1 for the sake of convenience. In this orientation, a top surface 34 of the cell case 20, provided with an external cathode terminal 50 and an external anode terminal 52, faces vertically upward. A direction in which the long side of the

cell case 20 of the battery cell 1 extends is defined as a lateral direction X. A direction in which the short side of the cell case 20 extends is defined as a longitudinal direction Y (downward with respect to the height). A direction orthogonal to both the lateral direction X and the longitudinal direction Y is defined as a thickness-wise direction Z of the cell case 20. In the following description, the lateral direction X extends sideward.

The battery cell 1 shown in FIG. 1 is a rechargeable battery that uses a non-aqueous electrolyte solution as an electrolyte. In case of a lithium-ion rechargeable battery, electric energy is charged or discharged when lithium ions, serving as charge carriers, move between a cathode and an anode.

As shown in FIG. 1, the battery cell 1 includes rolls of electrode bodies 10 and 11, the cell case 20, the non-aqueous electrolyte solution (not shown), and elastic members 70. Details of the elastic member 70 will be described later. In the battery cell 1 of the first embodiment, the two electrode bodies 10 and 11 are accommodated in a single cell case 20, and are arranged side by side in the lateral direction X of the cell case 20. The battery cell 1 of the first embodiment includes two electrode bodies 10 and 11 that are connected in series. However, there is no limitation to the number of electrode bodies accommodated in a single cell case 20, and one or three or more electrode bodies may be housed in one cell case 20. FIG. 1 does not show components other than the cell case 20, and the electrode bodies 10 and 11 accommodated in the cell case 20.

### Electrode Body 10, 11

The electrode bodies 10 and 11 are each formed by rolling a stack of a cathode plate and an anode plate with a separator arranged in between, and flattening the roll. In the electrode body 10, 11, a strip of cathode plate and a strip of anode plate are stacked with two strips of separator arranged in between. The cathode plate and the anode plate are rolled about a rolling axis, and then pressed into a flattened shape. The rolling axis is parallel to the Y-axis that is orthogonal to the long sides of the cathode plate and the anode plate.

The cathode plate of a cathode includes a cathode mixture layer formed on at least one of two opposite surfaces of a cathode current collector. Preferably, the cathode mixture layer is formed on both surfaces of the cathode current collector to improve battery performance qualities. The cathode plate may contain any materials that can be used in a lithium-ion rechargeable battery.

The cathode current collector may be, for example, a foil of a metal that contains aluminum as a main component. The cathode mixture layer contains a cathode active material capable of reversibly storing and releasing lithium ions, which are charge carriers. The cathode active material may be, for example, a lithium transition metal composite oxide, such as a lithium nickel cobalt manganese composite oxide. The cathode mixture layer may contain an additional element other than the cathode active material. Examples of the additional element include a conductive material, a binder, and various additives. The conductive material may be, for example, a carbon material, such as graphite, acetylene black (AB), carbon nanotubes (CNT), or carbon nanofibers (CNF). The binder may be, for example, polyvinylidene fluoride (PVdF) or the like.

The anode plate of an anode includes an anode mixture layer formed on at least one of two opposite surfaces of a strip of an anode current collector. Preferably, the anode mixture layer is formed on both surfaces of the anode current collector to improve battery performance qualities. The anode plate may contain any materials that can be used in a lithium-ion rechargeable battery. The anode current collector may be, for example, a foil of a metal that contains copper as a main component. The anode mixture layer contains an anode active material capable of reversibly storing and releasing the charge carriers. The anode active material may be, for example, a carbon material, such as graphite or the like. The anode mixture layer may contain an additional element other than the anode active material.

Examples of the additional element include a binder, a dispersant, and various additives. The binder may be, for example, rubber, such as styrene-butadiene rubber (SBR) or the like. The dispersant may be, for example, cellulose, such as carboxymethyl cellulose (CMC) or the like.

The separator is disposed between the cathode plate and the anode plate to insulate the cathode plate and the anode plate. Also, the separator retains the non-aqueous electrolyte solution. The separator may be any separator that can be used in a lithium-ion rechargeable battery. The separator may be a porous sheet formed from resin, such as cellulose or an olefin-based resin (e.g., polyethylene (PE), polypropylene (PP), or the like). The separator may have a single-layer structure or a multi-layer structure (for example, a three-layer structure in which a PP layer is formed on both surfaces of a PE layer). In addition, a heat-resistant layer (HRL) may be formed on a surface of the separator.

### Cell Case 20

As shown in FIGS. 1 to 3, the cell case 20 accommodates the electrode bodies 10 and 11 together with the non-aqueous electrolyte solution. The cell case 20 has a shape of a box that is flat in the thickness-wise direction Z. The cell case 20 is molded from an insulating resin. When the material of the cell case 20 includes an insulating resin, the cell case 20 may be shaped or recessed more easily, as compared to when the material includes metal, for example. Nonetheless, the material of the cell case 20 is not limited to resin.

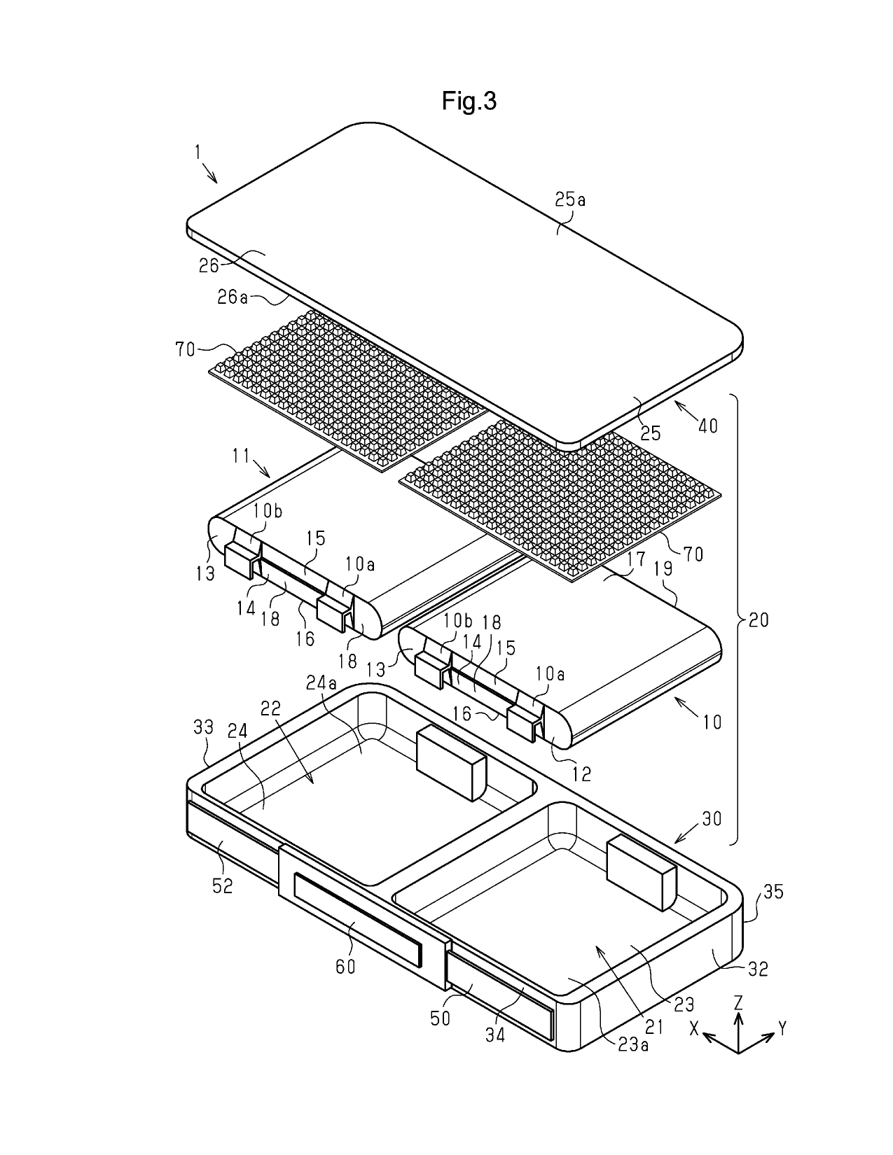

FIG. 3 is an exploded perspective view of the battery cell 1 in accordance with the first embodiment. As shown in FIG. 3, in the battery cell 1 of the first embodiment, the cell case 20 includes a case body 30 and a lid 40. The case body 30 includes first opposing portions 23 and 24. The lid 40 includes second opposing portions 25 and 26. One of the first opposing portions 23 and 24 and a corresponding one of the second opposing portions 25 and 26 serve as “two opposing side walls” of the present disclosure. The case body 30 is a box-shaped member that is flat in the thickness-wise direction Z. The case body 30 includes a side surface 31, the top surface 34, a bottom surface 35, a first end surface 32, and a second end surface 33. When the case body 30 is oriented as shown in FIG. 1, these surfaces of the case body 30 have the following positional relationship. The side surface 31 faces the lid 40 in the thickness-wise direction Z of the cell case 20. The first end surface 32 and the second end surface 33 face each other in the lateral direction X of the cell case 20. The top surface 34 and the bottom surface 35 face each other in the longitudinal direction (height-wise direction) Y of the cell case 20.

The lid 40 is a substantially rectangular plate attached to the case body 30 to close the case body 30. The lid 40 seals the case body 30 in which the electrode bodies 10 and 11 are accommodated. The lid 40 is adhered to or welded to the open end of the case body 30. This provides an airtight seal for the cell case 20.

### Non-Aqueous Electrolyte Solution

The non-aqueous electrolyte solution (not shown) may be any electrolyte fluid that can be used in a lithium-ion rechargeable battery. The non-aqueous electrolyte solution is a composition containing a supporting electrolyte in a non-aqueous solvent. The non-aqueous solvent may be, for example, an aprotic solvent, such as carbonates, esters, ethers, or the like. Among the aprotic solvents, it is preferred that the non-aqueous solvent be carbonates, such as ethylene carbonate (EC), diethyl carbonate (DEC), dimethyl carbonate (DMC), ethyl methyl carbonate (EMC), or the like. A single type of non-aqueous solvent may be used alone. Alternatively, two or more types of non-aqueous solvents may be used in combination. The supporting electrolyte may be, for example, lithium salt, such as LiPF6, LiBF4, LiClO4, or the like. The electrolyte solution may contain other additives.

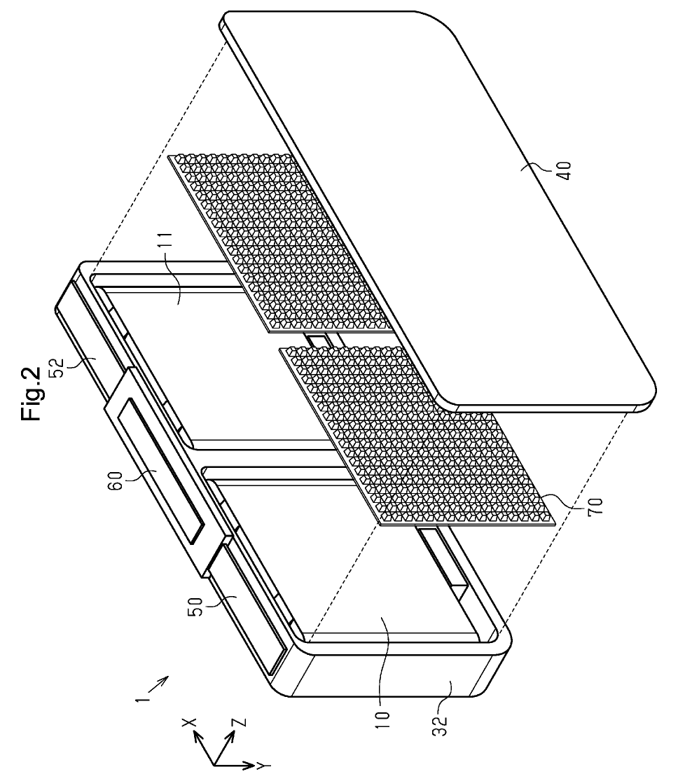

FIG. 2 is a schematic diagram showing the structure of the battery cell 1 in accordance with the first embodiment, by separating the lid 40 and the elastic members 70.

As shown in FIG. 2, the electrode bodies 10 and 11 are accommodated in compartments 21 and 22, an insulating cover 60 is attached to the case body 30, and the lid 40 is placed on the case body 30. In the battery cell 1 of the first embodiment, the electrode bodies 10 and 11 are first accommodated in the compartments 21 and 22, respectively. Then, the non-aqueous electrolyte solution is injected into the compartments 21 and 22 to impregnate the electrode bodies 10 and 11. Subsequently, the lid 40 is adhered to the case body 30 to cover the two compartments 21 and 22.

FIG. 2 shows an example in which a single lid 40 is provided for the two compartments 21 and 22; however, the lid 40 may be provided for each of the two compartments 21 and 22. This may facilitate welding of the lids 40 to the compartments 21 and 22. Specifically, a welding pressure applied to the electrode bodies 10 and 11 may be adjusted by changing the shapes of the lids 40 according to dimensional differences of the electrode bodies 10 and 11.

### External Cathode Terminal 50 and External Anode Terminal 52

As shown in FIG. 3, in the battery cell 1 of the first embodiment, the external cathode terminal 50, an intermediate terminal (not shown), and the external anode terminal 52 are insert-molded in the case body 30. Further, the compartments 21 and 22 for the electrode bodies 10 and 11 are formed in the case body 30.

The cathode of the electrode body 10 is connected to the external cathode terminal 50. The external cathode terminal 50 is formed from, for example, a metal containing aluminum as a main component. The anode of the electrode body 11 is connected to the external anode terminal 52. The external anode terminal 52 is formed from, for example, a metal containing copper as a main component.

The insulating cover 60 is arranged to cover the intermediate terminal (not shown) on the top surface 34.

In the case body 30, the compartments 21 and 22 are arranged side by side and are separated from each other in the lateral direction X of the cell case 20. The compartment 21 receives the electrode body 10, and the compartment 22 receives the electrode body 11. In an accommodated state, a cathode tab group 10a of the electrode body 10 is joined to the external cathode terminal 50, and an anode tab group 10b of the electrode body 10 is joined to an intermediate anode terminal (not shown). Further, a cathode tab group 10a of the electrode body 11 is joined to an intermediate cathode terminal (not shown), and an anode tab group 10b of the electrode body 11 is joined to the external anode terminal 52.

In the battery cell 1 of the first embodiment, the electrode bodies 10 and 11 are first accommodated in the compartments 21 and 22. Then, the electrolyte solution is injected into the compartments 21 and 22 from the open side to impregnate the electrode bodies 10 and 11. Subsequently, the lid 40 is adhered to the case body 30 to close the compartments 21 and 22, such that the battery cell 1 is manufactured.

In the manufactured battery cell 1, the external cathode terminal 50 and the external anode terminal 52 are aligned with each other on the same plane. Therefore, a current path of the battery cell 1 extends through regions of the electrode bodies 10 and 11 that are relatively close to the terminal arrangement surface, and the current path has minimal meandering with respect to the terminal arrangement surface. As a result, the battery cell 1 of the first embodiment has a minimal battery resistance.

The flattened electrode body 10, 11 has curved portions 12 and 13 at two opposite ends in the lateral direction X. The curved portions 12 and 13 have curved outer surfaces. Further, the flattened electrode body 10, 11 has flat portions 14 and 15 extending between the curved portions 12 and 13. The flat portions 14 and 15 have flat outer surfaces. The flat portions 14 and 15 face each other in the thickness-wise direction Z of the electrode body 10, 11.

Such an electrode body 10, 11 has flat surfaces 16 and 17. The flat surface 16 extends on an X-Y plane at a lower end of the electrode body 10, 11 in the thickness-wise direction Z. The flat surface 17 extends on an X-Y plane at an upper end of the electrode body 10, 11 in the thickness-wise direction Z. The flat surfaces 16 and 17 face each other in the thickness-wise direction Z. The flat surfaces 16 and 17 are substantially rectangular.

The electrode body 10, 11 has end surfaces 18 and 19. The end surface 18 is located at an end of the electrode body 10, 11 relatively close to the electrodes in the longitudinal direction Y. The end surface 19 is located at an end of the electrode body 10, 11 opposite to the end surface 18 in the longitudinal direction Y.

The cathode plate, the anode plate, and the separators are layered in the end surfaces 18 and 19, and the end surfaces 18 and 19 are exposed from the electrode body 10, 11.

The electrode body 10, 11 is accommodated in the compartment 21, 22 in a state in which the rolling axis of the electrode body 10, 11 is parallel to the longitudinal direction Y of the cell case 20. In the electrode body 10, 11 accommodated in the compartment 21, 22, the curved portions 12 and 13 are located at two opposite sides of the electrode body 10, 11 in the lateral direction X of the cell case 20, and the flat portions 14 and 15 are located at two opposite sides of the electrode body 10, 11 in the thickness-wise direction Z of the cell case 20.

The cell case 20 includes two opposing surfaces 23a and 25a facing the flat surfaces 16 and 17 of the electrode body 10, and two opposing surfaces 24a and 26a facing the flat surfaces 16 and 17 of the electrode body 11. The opposing surfaces 23a and 24a oppose the opposing surfaces 25a and 26a in the thickness-wise direction Z of the cell case 20.

In the cell 1 of the first embodiment, the case body 30 includes the opposing surface 23a serving as one of “two opposing side walls” that faces the flat surface 16 of the electrode body 10, and the opposing surface 24a serving as one of “two opposing side walls” that faces the flat surface 16 of the electrode body 11. The lid 40 includes the opposing surface 25a serving as the other one of “two opposing side walls” that faces the flat surface 17 of the electrode body 10, and the opposing surface 26a serving as the other one of “two opposing side walls” that faces the flat surface 17 of the electrode body 11.

The opposing surface 23a, 24a is an inner surface of the first opposing portion 23, 24 of the side surface 31 that faces the flat portion 14. The opposing surface 25a, 26a is an inner surface of the second opposing portion 25, 26 of the lid 40 that faces the flat portion 15. The opposing surface 23a, 24a, 25a, 26a faces or defines the compartment 21, 22.

### Pressure Change of Battery Cell 1

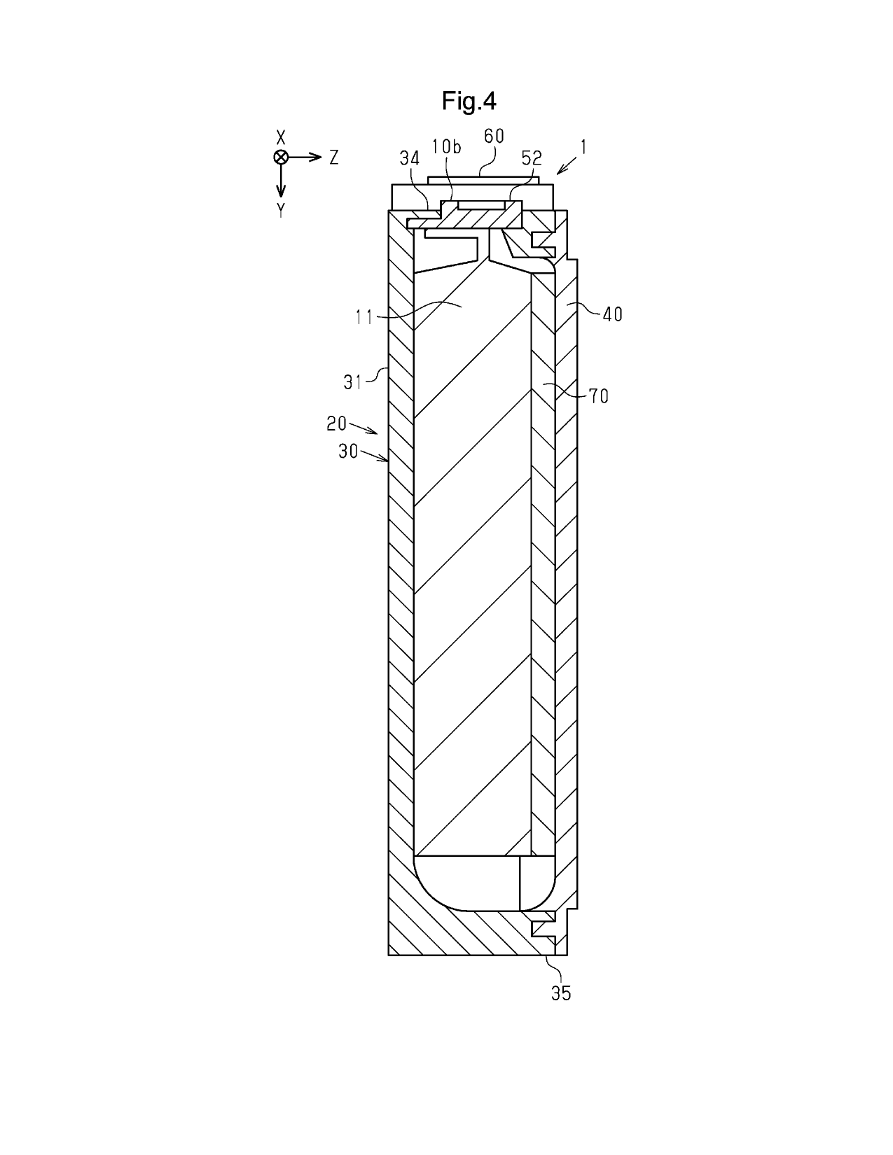

FIG. 4 is a cross-sectional view taken along line IV-IV shown in FIG. 1. FIG. 4 shows the electrode body 11 accommodated in the cell case 20 that has the same structure as the electrode body 11 accommodated in the cell case 20 shown in FIG. 3. Hereafter, the electrode body 11 accommodated in the cell case 20 is used as an example to describe problems that may occur when charging and discharging of the battery cell 1. As shown in FIG. 4, the elastic member 70 is disposed between the electrode body 11 and the lid 40.

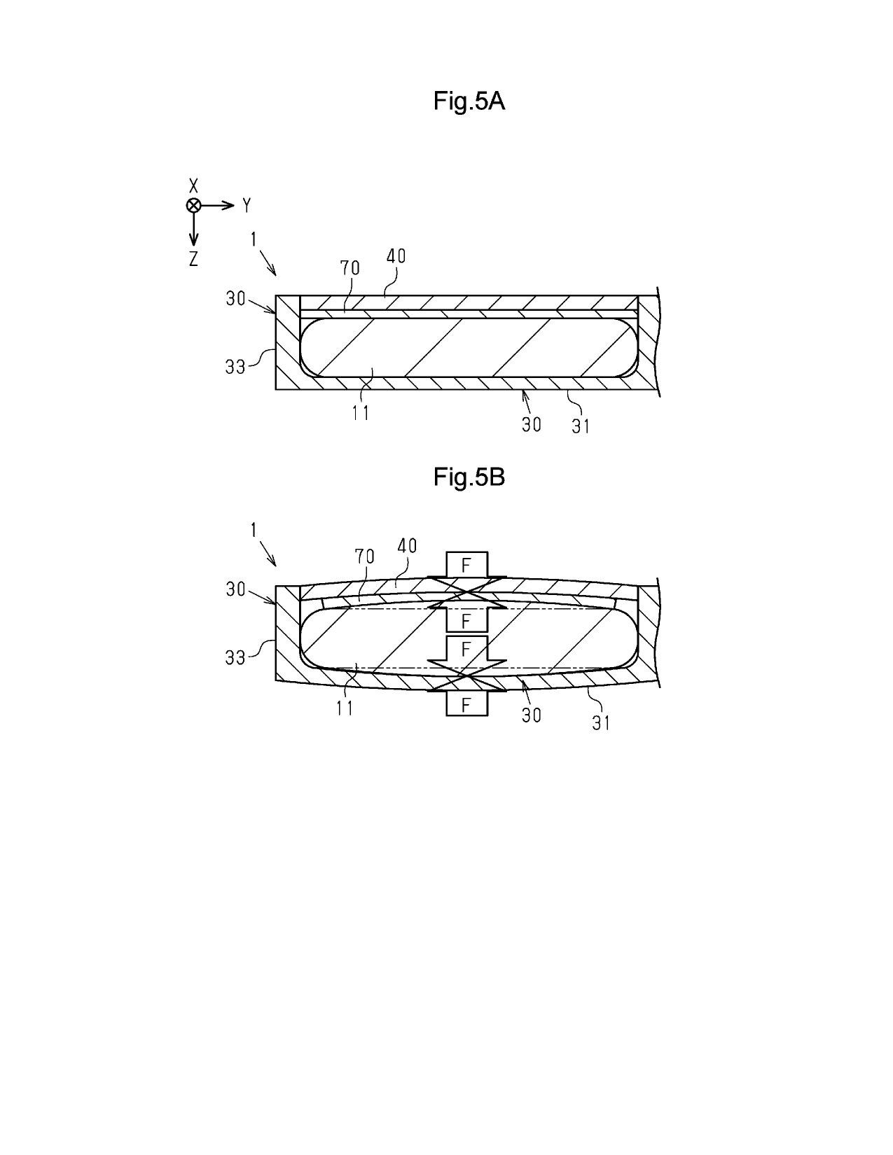

FIG. 5A is a cross-sectional view of the battery cell 1 taken along line V-V shown in FIG. 1, in a state in which the electrode body 11 is in an initial state. FIG. 5B is a cross-sectional view of the battery cell 1 taken along line V-V shown in FIG. 1, in a state in which the electrode body 11 is expanded. When the battery cell 1 shown in FIG. 5A is charged or discharged, the electrode body 11 sealed in the cell case 20 expands or contracts. Also, gas is generated from the electrode body 11. Specifically, when the battery cell 1 is charged or discharged, the electrode body 11 in the cell case 20 expands or contracts in the thickness-wise direction Z of the electrode body 11 as lithium ions are released and stored. In addition, various chemical reactions generate gas, such that the temperature rises and the internal pressure increases.

As shown in FIG. 5B, when the electrode body 11 in the cell case 20 expands and gas is generated from the electrode body 11 in the battery cell 1, force F (N) presses the cell case 20 from the inside to the outside in the thickness-wise direction Z. Then, reaction force F′ (N) against the force F (N) acts on the electrode body 11, which holds the non-aqueous electrolyte solution. This pushes the electrolyte solution out of the electrode body 11 from the end surfaces 18 and 19, such that the non-aqueous electrolyte solution leaks from the electrode body 11.

The leaked non-aqueous electrolyte solution flows down along the opposing surfaces 24a and 26a and collects at the bottom of the cell case 20. The electrolyte solution collected at the bottom of the cell case 20 impregnates the electrode body 11 from the end surface 19. In this manner, the electrolyte solution leaked from the electrode body 11 is reabsorbed by the electrode body 11 from the end surface 19.

However, as charging and discharging are repeatedly performed, the force F (N) generated by expansion of the electrode body 11 increases, and thus the reaction force F′ (N) against the force F (N) also increases. Accordingly, even when the electrode body 11 is impregnated with the electrolyte solution from the end surface 19, the salt concentration of the electrolyte solution retained in the electrode body 11 may become uneven or the electrolyte solution may become scarce (dry up) during charging and discharging. In such cases, the internal resistance of the battery cell 1 may increase and the battery performance may deteriorate.

### Elastic Member 70

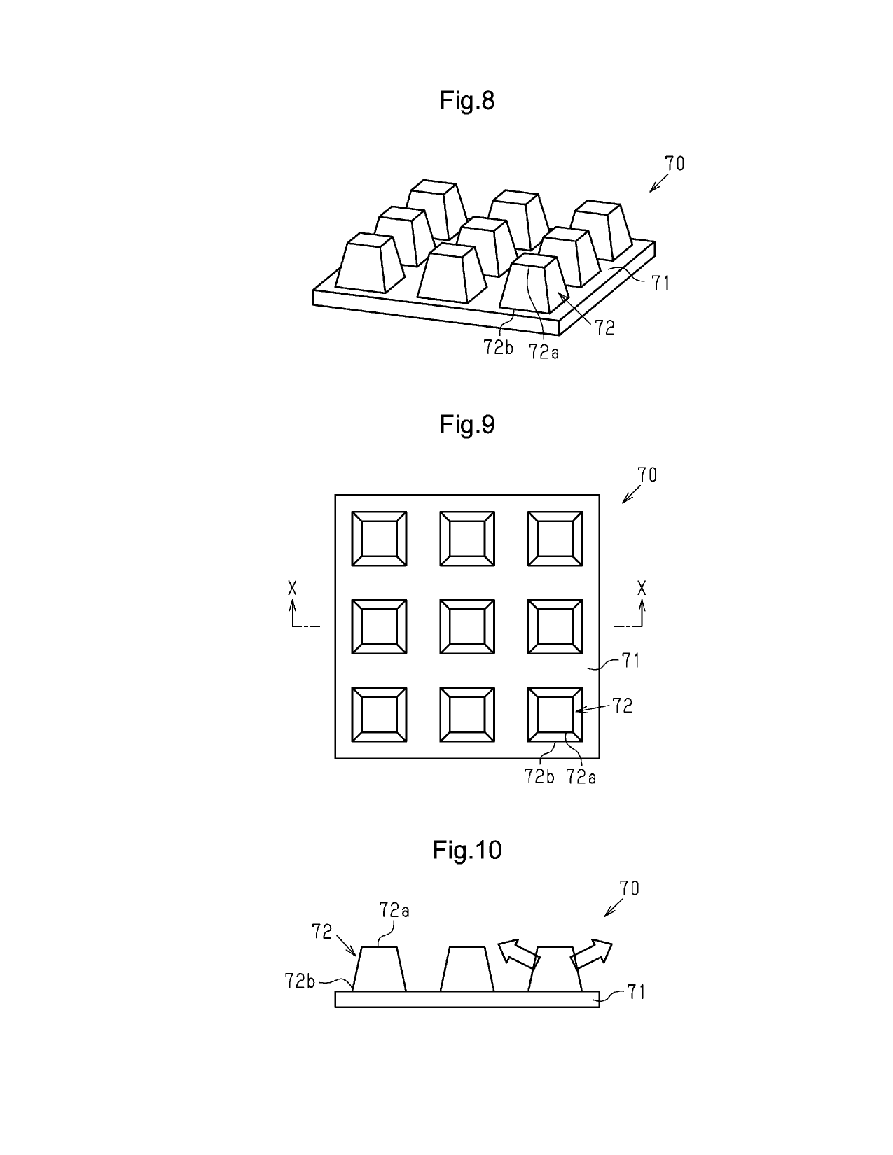

FIG. 8 is a perspective view of the elastic member 70 in accordance with the first embodiment. FIG. 9 is a plan view of the elastic member 70 in accordance with the first embodiment. FIG. 10 is a cross-sectional view taken along line X-X shown in FIG. 9. The elastic member 70 of the first embodiment includes a close-contact portion 71, and projections 72 arranged on the close-contact portion 71. In order to solve the above-described problems resulting from the pressure changes the elastic member 70 of the first embodiment has the following structure.

### Close-Contact Portion 71

As shown in FIGS. 8 -10, the elastic member 70 includes the close-contact portion 71 having a shape of a substantially square sheet. As shown in FIGS. 1 - 4, the close-contact portion 71 covers the electrode body 10, 11 in the compartment 21, 22 at a side of the electrode body 10, 11 relatively close to the lid 40 in the thickness-wise direction Z. The case body 30 restricts movement of the close-contact portion 71 in the lateral direction X and the longitudinal direction Y.

The material of the elastic member 70 of the first embodiment is elastic, and preferably, capable of retaining the non-aqueous electrolyte solution. Further, it is preferred that the elastic member 70 be resistant to corrosion by the non-aqueous electrolyte solution. It is even more desirable that the elastic member 70 have a high heat resistance.

In the elastic member 70 of the first embodiment, the close-contact portion 71 and the projections 72 are integrally molded from the same material.

### Functions of Projection 72

FIG. 7 is a schematic diagram illustrating transfer of the reaction force F′(N) through the projection 72 in accordance with the first embodiment and a comparative projection 72′ having a uniform cross-sectional area.

The projection 72′ of a conventional elastic member 70 has a shape of a post in which the cross-sectional area (mm²) is uniform between a distal end 72a and a basal end 72b proximate to the close-contact portion 71. When the conventional elastic member 70 is formed from a single material, the reaction force F′ (N) evenly acts on the entire projection 72′.

In contrast, in the elastic member 70 of the first embodiment, the projection 72 has a shape of a truncated quadrangular pyramid, and the cross-sectional area (mm²) differs between the distal end 72a and the basal end 72b proximate to the close-contact portion 71. In this case, the reaction force F′ (N) exerts a greater pressure per unit area (N/mm²) at the distal end 72a, where the cross-sectional area (mm²) is relatively small. In this disclosure, a term “elastic-member compression ratio CR (%)” (or, simply, “compression ratio CR (%)”) indicates a ratio (%) of a length of a compressed elastic member 70 relative to the initial length of the elastic member 70, which is represented by 0%. Accordingly, when the compression ratio CR (%) is higher, the elastic member 70 is more compressed. Even when the elastic member 70 is formed from a single material, the compression ratio CR (%) of the elastic member 70 is higher at the distal end 72a, where the cross-sectional area (mm²) is relatively small. That is, a portion having a relatively small cross-sectional area (mm²) is more easily deformed. The projection 72 is deformed to absorb some of the pressure exerted by the reaction force F′, thereby alleviating the pressure transferred through the close-contact portion 71 to the electrode body 11.

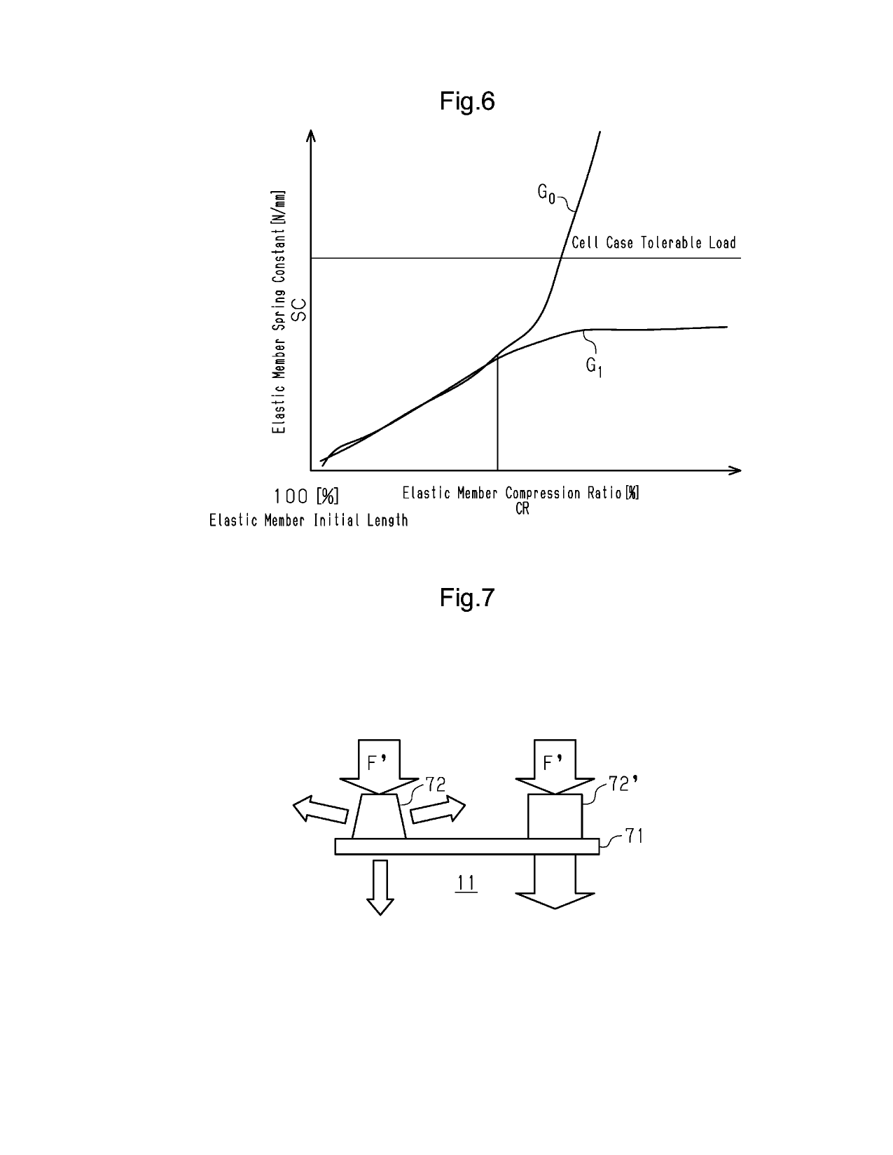

FIG. 6 is a graph illustrating a ratio of “elastic-member spring constant SC (N/mm²)” (or, simply, “spring constant SC (N/mm) ”) to “elastic-member compression ratio (%)” of the elastic member 70 in accordance with the first embodiment and a comparative elastic member 70 having a uniform thickness. Line G₀ represents the conventional elastic member 70, which serves as a comparative example. Line G1 represents the elastic member 70 of the first embodiment. The conventional elastic member 70 (not shown) may be a sheet having a uniform thickness.

As line G₀ shown in FIG. 6 indicates, when the conventional elastic member 70 is a sheet having a uniform thickness, a change in the spring constant SC (N/mm) of the elastic member 70 relative to the elastic-member compression ratio CR (%) is, at first, substantially constantly proportional. However, when the compression ratio CR (%) of the elastic member 70 becomes greater than or equal to a certain value, pores of the elastic member 70 are closed, such that the elastic-member spring constant SC (N/mm) abruptly increases as the elastic member 70 further deforms. Accordingly, if the force F (N) increases and the compression ratio CR (%) exceeds a predetermined value, the lid 40 reaches its mechanical strength limit.

In contrast, when the projection 72 of the first embodiment has a cross-sectional area (mm²) that is decreased from the basal end 72b toward the distal end 72a, the projection 72 may be deformed by a relatively small force F(N). As line G1 shown in FIG. 6 indicates, a change in the spring constant SC (N/mm) of the elastic member 70 relative to the elastic-member compression ratio CR (%) is, at first, substantially constantly proportional. However, when the compression ratio CR (%) of the elastic member 70 becomes greater than or equal to a certain value, the distal end 72a of the projection 72 is deformed to absorb the force (N), such that the change in the spring constant SC (N/mm) of the elastic member 70 relative to the elastic-member compression ratio CR (%) decreases. Accordingly, even if the elastic-member compression ratio CR (%) increases, the spring constant SC (N/mm) of the elastic member 70 does not reach the mechanical strength limit of the lid 40.

A person skilled in the art may select an optimal material for the elastic member 70. Also, an initial Young’s modulus (N/mm²) or a porosity (%) of the elastic member 70 may be set by a person skilled in the art in accordance with the configuration of the battery cell 1, the composition of the non-aqueous electrolyte solution, or the like.

### Structural Examples of Elastic Member 70

In the elastic member 70 shown in FIGS. 8 to 10, for illustrative purposes, the projections 72 are arranged in a matrix pattern with three rows and three columns. The elastic member 70 shown in FIGS. 8 to 10 is merely an example, and the elastic member 70 may have, for example, at least two rows and two columns of the projections 72. There is no upper limit to the numbers of rows and columns, and a large number of projections 72 may form, for example, thirty rows and thirty columns. Further, the numbers of rows and columns may differ (for example, twenty rows and twenty-five columns) to match the shapes of the electrode bodies 10 and 11.

In the first embodiment, the projections 72 each have a shape of a truncated square pyramid, and the cross sections of the distal end 72a and the basal end 72b are square. The cross-sectional areas (mm²) of the distal end 72a and the basal end 72b may be optimized by a person skilled in the art in accordance with the material or the like. Also, the height of the projection 72 in a projecting direction (thickness-wise direction Z) and the thickness of the close-contact portion 71 may be optimized by a person skilled in the art. Further, the interval between the basal ends 72b may be optimized in the same manner.

### Operation of the First Embodiment

In the first embodiment, the electrode body 10, 11 is accommodated in the cell case 20. The cell case 20 includes the case body 30 and the lid 40. The electrode body 10, 11 is formed by stacking a cathode plate and an anode plate with a separator arranged in between and rolling the stack. The elastic member 70 is disposed between the electrode body 10, 11 and the lid 40 that forms a side wall of the cell case 20. The elastic member 70 includes the close-contact portion 71 that is in close contact with the electrode body 10, 11, and the projections 72 projecting from the close-contact portion 71 toward the lid 40. The projections 72 each have a cross-sectional area, orthogonal to the projecting direction, that is decreased from the basal end 72b toward the distal end 72a.

Such a projection 72 has a spring constant SC (N/mm) that varies in the thickness-

wise direction Z. When a force F (N) is applied to the elastic member 70 in the thickness-wise direction Z, the spring constant SC (N/mm) increases in proportion to the compression ratio CR (%) in the thickness-wise direction Z. Then, when the compression ratio CR (%) in the thickness-wise direction Z becomes greater than a predetermined value, the projection 72 is deformed from the distal end 72a to absorb stress, such that a change in the spring constant SC (N/mm) relative to the compression ratio CR (%) in the thickness-wise direction Z decreases. In other words, even if the force F (N) becomes greater than a certain value, an increase in the pressure applied to the lid 40 remains negligible. In this manner, even when the electrode body 10, 11 significantly expands and the internal pressure is increased by generated gas, the lid 40 does not reach its mechanical strength limit. Further, when the force F (N) decreases, the elastic member 70 elastically secures the electrode body 10, 11 inside the cell case 20, so that the force F (reaction force F′) (N) acting on the electrode body 10, 11 does not fall below a predetermined value.

### Advantages of the First Embodiment

(1-1) The lithium-ion rechargeable battery of the first embodiment sufficiently tolerates various degrees of expansion and contraction of the battery cell 1.

(1-2) The elastic member 70 of the first embodiment is disposed between the electrode body 10, 11 and the lid 40 that forms the side wall of the cell case 20. The elastic member 70 includes the close-contact portion 71 that is in close contact with the electrode body 10, 11, and the projections 72 projecting from the close-contact portion 71 toward the lid 40. The projections 72 each have a cross-sectional area, orthogonal to the projecting direction, that is decreased from the basal end 72b toward the distal end 72a. Therefore, when the elastic member 70 receives a certain amount of force F (N), the elastic member 70 deforms to avoid an excess increase in the spring constant SC (N/mm). Accordingly, the force F (N) applied to the lid 40 is reduced. As a result, the cell case 20 of the battery cell 1 may be reduced in size, weight, or cost.

(1-3) The multiple projections 72 are arranged on the close-contact portion 71, so that the force F (N) applied to the lid 40 is distributed.

(1-4) The projections 72 are arranged in a matrix pattern that extends in the lateral direction X and the longitudinal direction Y. The lateral direction X is orthogonal to the thickness-wise direction Z, which is also the projecting direction. The longitudinal direction Y is orthogonal to both the projecting direction and the lateral direction X. In other words, the projections 72 are arranged in a matrix pattern that extends in a plane orthogonal to the thickness-wise direction Z, which is also the projecting direction. This plane is parallel to the lateral direction X and the longitudinal direction Y. With this configuration, the force F (N) applied to the lid 40 is evenly distributed.

(1-5) The projections 72 each have a shape of a truncated quadrangular pyramid that projects in the projecting direction. Therefore, the change ratio of the spring constant SC (N/mm) varies in the projecting direction (thickness-wise direction Z).

(1-6) When the elastic member 70 is compressed in the thickness-wise direction Z, a change ratio of the spring constant SC (N/mm) relative to the compression ratio CR (%) of the elastic member 70 in an initial state is, at first, constant. However, when the compression ratio CR (%) becomes greater than a predetermined value, the change ratio of the spring constant SC (N/mm) decreases. Therefore, even when the force F (N) increases, the spring constant SC (N/mm) does not become excessively large.

(1-7) The elastic member 70 is porous, so that the elastic member 70 may absorb and retain the non-aqueous electrolyte solution or may be impregnated with the non-aqueous electrolyte solution. This allows for efficient use of the non-aqueous electrolyte solution.

(1-8) In the lithium-ion rechargeable battery of the first embodiment, the cell case 20 has a shape of a flat box, and the electrode body 10, 11 is flattened. Therefore, a plurality

of cell cases 20 may be stacked in the thickness-wise direction Z as battery packs without using a restraining tool. In addition, since the thickness of each cell case 20 is relatively small, a large number of cell cases 20 may be appropriately stacked.

(1-9) The rechargeable battery in accordance with the first embodiment is a lithium-ion rechargeable battery, which is a non-aqueous electrolyte rechargeable battery. The first embodiment of the present disclosure may be applied to any battery in which the electrode body 10, 11 expands as lithium ions are absorbed.

### Second Embodiment

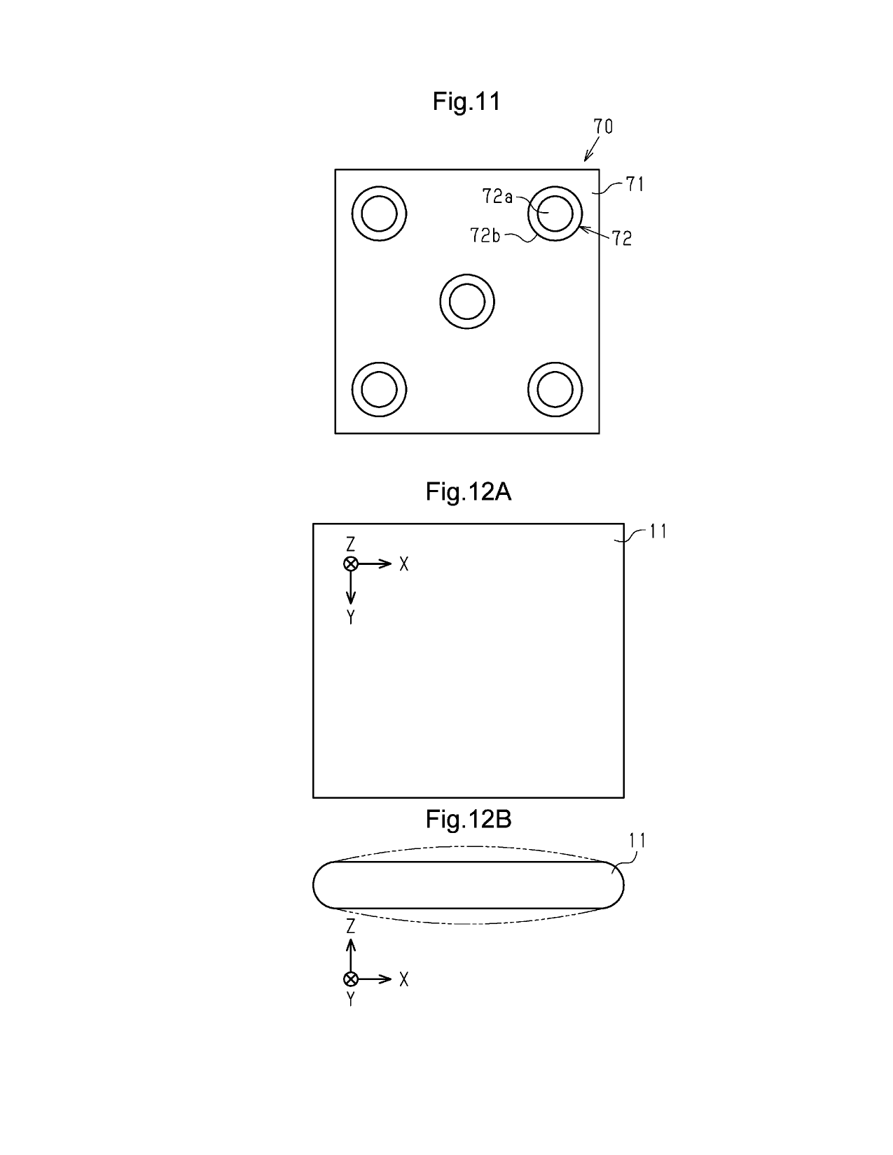

FIG. 11 is a plan view of an elastic member 70 in accordance with a second embodiment. The second embodiment differs from the first embodiment in the shapes and arrangement of the projections 72. The description hereafter will focus on the differences from the first embodiment. The projections 72 in accordance with the first embodiment each have a shape of a truncated square pyramid. In the second embodiment, the projections 72 each have a shape of a truncated circular cone.

Furthermore, the projections 72 are arranged in a staggered pattern. Alternatively, the projections 72 may be arranged at equal intervals to form an equilateral triangle (not shown).

In the same manner as the first embodiment, a person skilled in the art may optimize, in consideration of the application, the number of projections 72, the cross-sectional areas of the distal end 72a and the basal end 72b, and the height of the projections 72 in the projecting direction (thickness-wise direction Z).

### Advantages of the Second Embodiment

(2-1) The projections 72 each have a shape of a truncated circular cone, so that a pressure is transferred more evenly.

(2-2) The projections 72 may be staggered or arranged at equal intervals, so that a pressure may be transferred more evenly.

### Third Embodiment

FIG. 12A is a plan view of a roll of the electrode body 11 in an expanded state. FIG. 12B is a front view of the roll of the electrode body 11 in the expanded state, as viewed in the longitudinal direction Y.

The electrode body 11 is formed by stacking a cathode plate and an anode plate with a separator arranged in between, rolling the stack into a cylindrical shape, and pressing to flatten the roll.

Accordingly, the anode plate expands, for example, when lithium ions are intercalated to the anode active material during charging. In this case, a central part of the electrode body 11 extending in the longitudinal direction Y, shown in FIG. 12A, is structurally likely to expand. The longitudinal direction Y is parallel to the rolling axis of the electrode body 11. When the expanded electrode body 11 is viewed in the longitudinal direction Y, as shown in FIG. 12B, the central part of the electrode body 11 is increased in thickness.

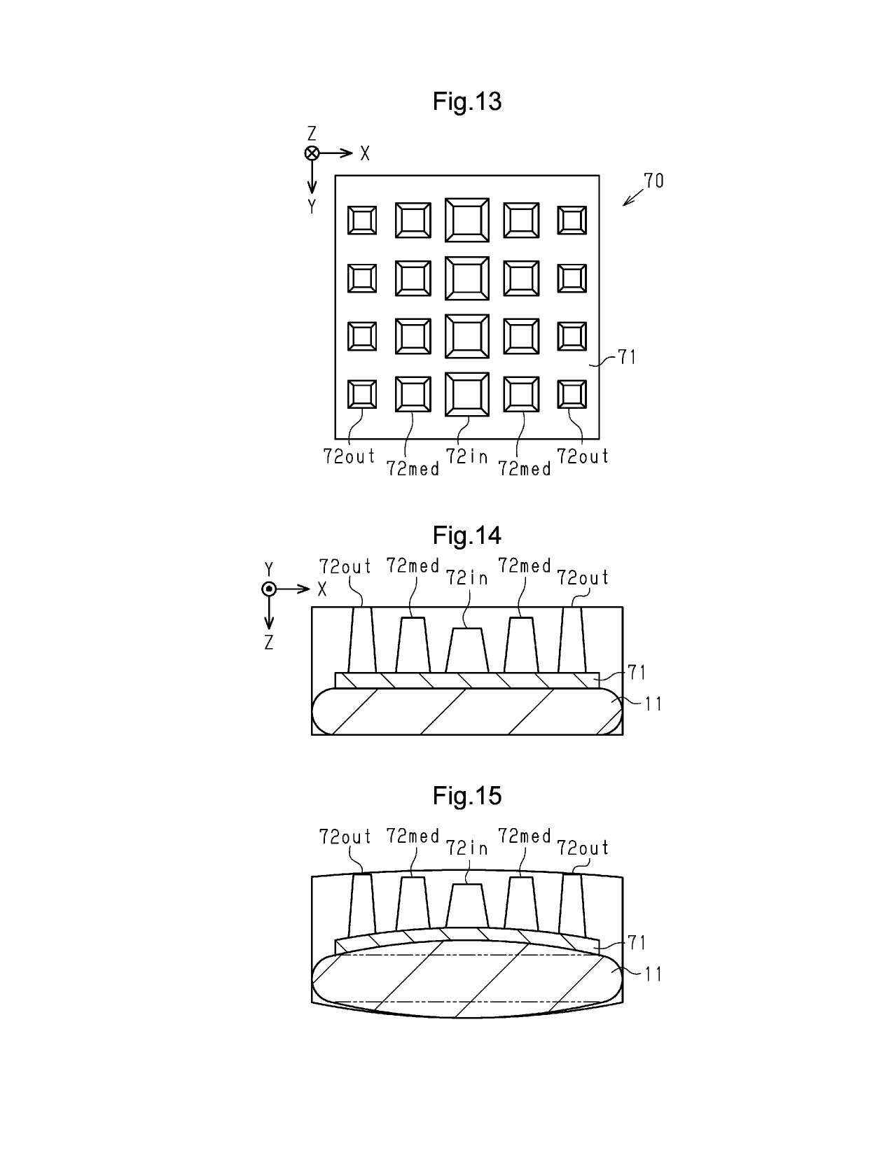

FIG. 13 is a plan view of an elastic member 70 in accordance with a third embodiment. FIG. 14 is a front view of the elastic member 70 in accordance with the third embodiment. FIG. 15 is a front view of the elastic member 70 shown in FIG. 14, in a state in which the electrode body 11 is expanded from the state shown in FIG. 14.

As shown in FIG. 13, projections 72ᵢₙ are arranged at a central part of the close-contact portion 71 in the lateral direction X. The projections 72ᵢₙare aligned in the longitudinal direction Y that is parallel to the rolling axis of the electrode body 11. Further, projections 72ₒᵤₜare arranged at two opposite end parts of the close-contact portion 71 in the lateral direction X. The projections 72ₒᵤₜare aligned in the longitudinal direction Y that is parallel to the rolling axis of the electrode body 11. In the third embodiment, the height (mm) of the projections 72ᵢₙ arranged at the central part of the close-contact portion 71 in the lateral direction X is set to be less than the height (mm) of the projections 72ₒᵤₜ arranged at the end parts of the close-contact portion 71 in the lateral direction X. Further, the cross-sectional areas (mm²) of the distal end 72a and the basal end 72b of the projections 72ᵢₙ arranged at the central part of the close-contact portion 71 in the lateral direction X are set to be greater than the cross-sectional areas (mm²) of the projections 72ₒᵤₜ arranged at the end parts of the close-contact portion 71 in the lateral direction X.

In other words, the height (mm) of the projections 72ₒᵤₜ arranged at the end parts of the close-contact portion 71 in the lateral direction X is set to be greater than that of the projections 72ᵢₙ arranged at the central part of the close-contact portion 71 in the lateral direction X. Further, the cross-sectional areas (mm²) of the distal end 72a and the basal end 72b of the projections 72ₒᵤₜ arranged at the end parts of the close-contact portion 71 in the lateral direction X are set to be less than those of the projections 72ᵢₙ arranged at the central part of the close-contact portion 71 in the lateral direction X.

The operation of the projections 72 in accordance with the third embodiment will now be described. As shown in FIG. 14, when the electrode body 10, 11 is not expanded, the distal ends 72a of the projections 72ₒᵤₜ arranged at the end parts of the close-contact portion 71 in the lateral direction X are in contact with the lid 40. In contrast, the distal ends 72a of the projections 72ᵢₙ arranged at the central part of the close-contact portion 71 in the lateral direction X are significantly separated from the lid 40.

As shown in FIG. 15, when the electrode body 10, 11 expands, although the distal ends 72a of the projections 72ₒᵤₜ are in contact with the lid 40, the displacement of the lid 40 is limited. Further, the expanded electrode body 10, 11 pushes the distal ends 72a of the projections 72ᵢₙ toward the lid 40.

As the electrode body 10, 11 further expands (not shown), the distal ends 72a the projections 72ᵢₙ come into contact with the lid 40. In this case, the force F (N) from the electrode body 10, 11 is transferred to the lid 40 and, in turn, the distal ends 72a of the projections 72ᵢₙ receive the reaction forces F′ (N) from the lid 40. The projections 72ᵢₙ are compressed to alleviate the stress (N) applied to the lid 40.

### Advantages of the Third Embodiment

(3-1) With the elastic member 70 of the third embodiment, at an initial stage of expansion of the electrode body 10, 11, only the distal ends 72a of the projections 72ₒᵤₜ arranged at the end parts of the close-contact portion 71 in the lateral direction X are in contact with the lid 40. Since the force F (N) is still relatively small, the elastic member 70 may sufficiently secure the electrode body 10, 11. When the electrode body 10, 11 further expands, the distal ends 72a of the projections 72ᵢₙ arranged at the central part of the close-contact portion 71 in the lateral direction X come into contact with the lid 40. In this case, although the force F (N) is increased, the compression ratio CR (%) of the projections 72ᵢₙ remains relatively small. Further, since the projections 72ᵢₙ have a greater cross-sectional area (mm²) than the projections 72ₒᵤₜ, the projections 72ᵢₙ have a greater spring constant SC (N/mm). Thus, even when the electrode body 10, 11 expands significantly and generates a relatively large force F (N), the projections 72ᵢₙ alleviate the force F(N) with a sufficient spring constant SC (N/mm) and a sufficient margin of the compression ratio CR (%).

(3-2) The projections 72ᵢₙ are arranged at the central part of the close-contact portion 71 in the lateral direction X, where the expansion of the electrode body 10, 11 is relatively significant. Therefore, the projections 72ᵢₙ sufficiently tolerate the displacement caused by expansion of the electrode body 10, 11.

### Fourth Embodiment

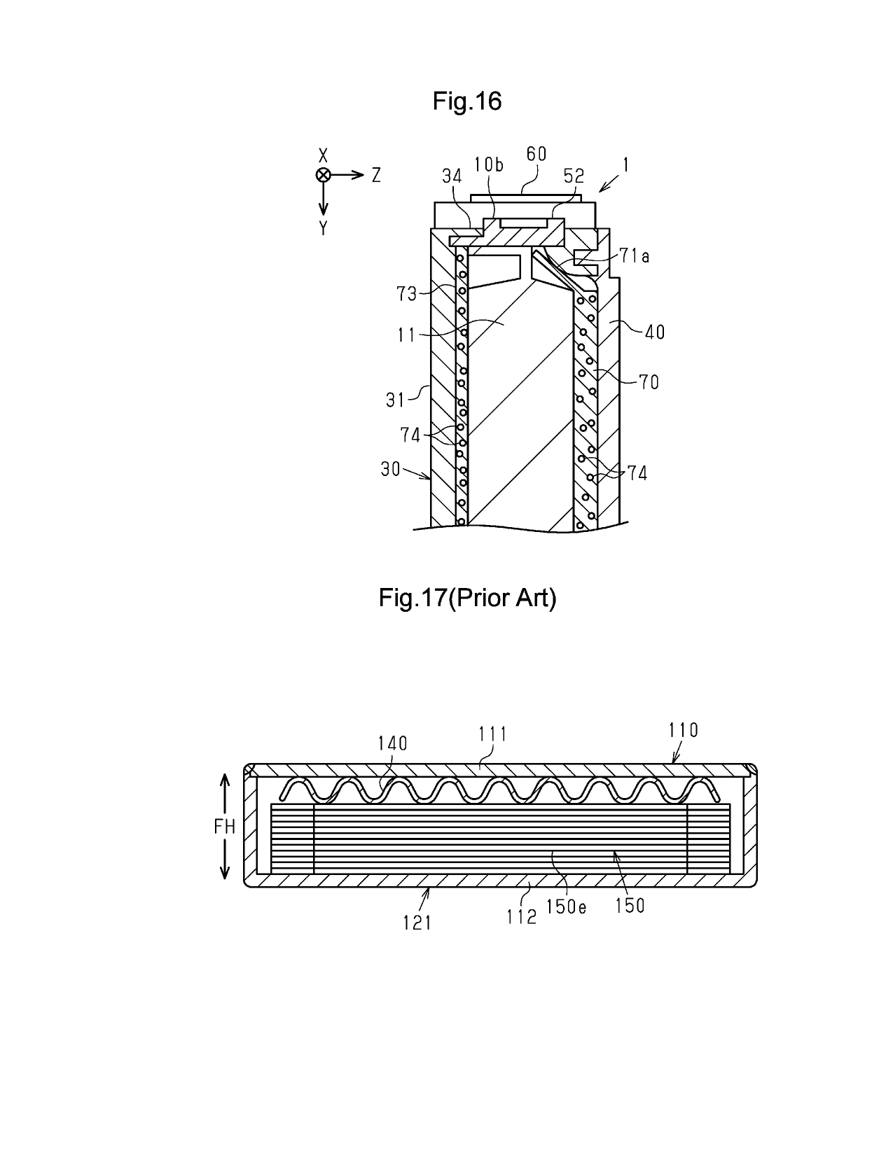

FIG. 16 is a cross-sectional view of an elastic member 70 in accordance with a fourth embodiment, taken along line IV-IV shown in FIG. 1. The elastic member 70 in accordance with the fourth embodiment has basically the same configuration as the elastic members 70 in accordance with the first to third embodiments. The difference from the above-described embodiments is that the elastic member 70 of the fourth embodiment includes an extension 71a. The elastic member 70 of the fourth embodiment is porous, in the same manner as the elastic member 70 of the first embodiment. Therefore, the elastic member 70 may absorb and retain the non-aqueous electrolyte solution. FIG. 16 shows the battery cell 1 having the same structure as the battery cell 1 shown in FIGS. 1 and 4. In FIGS. 1 and 4, the top surface 34 provided with the external cathode terminal 50 and the external anode terminal 52 faces upward. However, the battery cell 1 may also be used in an inverted orientation, in which the top surface 34 is located at the bottom and the bottom surface 35 is located at the top. Accordingly, FIG. 16 shows an example in which the battery cell 1 in accordance with the fourth embodiment is oriented such that the top surface 34 is located at the bottom and the bottom surface 35 is located at the top. In this case, a plurality of the battery cells 1 may be accommodated in a box-shaped container (not shown) and used as a battery pack. For example, bus bars are arranged at an inner bottom part of the container. In a case in which the battery cell 1 is used in such a manner, the non-aqueous electrolyte solution leaked from the electrode body 10, 11 would collect in the upper part of FIG. 16 by gravity. The collected non-aqueous electrolyte solution is separated from the electrode body 11, and therefore cannot act as a lithium-ion carrier.

When the battery cell 1 is oriented such that the top surface 34 is located at the bottom, the non-aqueous electrolyte solution leaked from the close-contact portion 71 collects at the upper part of FIG. 16 by gravity. Accordingly, the elastic member 70 of the fourth embodiment includes the extension 71a that extends from the close-contact portion 71 to a position where the non-aqueous electrolyte solution would collect by gravity.

Further, in the fourth embodiment, an electrolyte-solution retaining sheet 73 is disposed between the electrode body 10, 11 and the compartment 21, 22. The electrolyte-solution retaining sheet 73 has the same configuration as the close-contact portion 71. The electrolyte-solution retaining sheet 73 is a porous sheet that absorbs and retains the non-aqueous electrolyte solution. The electrolyte-solution retaining sheet 73 also extends to a position where the non-aqueous electrolyte solution collects by gravity. The electrolyte-solution retaining sheet 73 is a flat sheet that does not include the projections 72.

Although not shown in the drawings, when the top surface 34 is oriented upward, the extension 71a may be arranged to extend toward the bottom surface 35. Alternatively, the extension 71a may extend toward both surfaces 34 and 35. Also, the electrolyte-solution retaining sheet 73 may extend toward the bottom surface 35 or toward both surfaces 34 and 35.

In the fourth embodiment, in addition to the above-described configuration, the elastic member 70 contains capsules of a fire-prevention agent 74. The fire-prevention agent may be, for example, monobasic ammonium phosphate, ammonium sulfate, sodium hydrogen carbonate, or the like. The capsules containing the fire-prevention agent 74 may be formed from, for example, resin, such as polypropylene or the like. Typically, the capsules hermetically seal the fire-prevention agent inside, so that the fire-prevention agent does not come into contact with the non-aqueous electrolyte solution. When the temperature of the battery cell 1 becomes higher than or equal to a certain temperature, for example, 160°C, the capsules melt and the fire-prevention agent diffuses inside the battery cell 1 in order to prevent a fire.

### Advantages of the Fourth Embodiment

(4-1) In the fourth embodiment, the extension 71a extends from the porous sheet of the close-contact portion 71 to a position where the non-aqueous electrolyte solution collects by gravity. The extension 71a absorbs the collected non-aqueous electrolyte solution, so that the non-aqueous electrolyte solution contributes to the main reaction. In addition, capillary action of the porous sheet returns the collected non-aqueous electrolyte solution to the electrode body 10, 11.

(4-2) In the fourth embodiment, the elastic member 70 is in close contact with one side surface of the electrode body 10, 11, and the electrolyte-solution retaining sheet 73 is in close contact with the other side surface of the electrode body 10, 11. An end of the electrolyte-solution retaining sheet 73 extends to a position where the non-aqueous electrolyte solution collects by gravity. The electrolyte-solution retaining sheet 73 absorbs the collected non-aqueous electrolyte solution, so that the non-aqueous electrolyte solution contributes to the main reaction. In addition, capillary action of the electrolyte-solution retaining sheet 73 returns the non-aqueous electrolyte solution to the electrode body 10, 11.

(4-3) The electrolyte-solution retaining sheet 73 does not include the projections 72, so the thickness of the battery cell 1 is not adversely affected. The electrolyte-solution retaining sheet 73 is also formed by an elastic body. Therefore, the electrolyte-solution retaining sheet 73 and the elastic member 70 that are disposed between the cell case 20 and the electrode body 10, 11 sufficiently tolerate expansion of the electrode body 10, 11.

(4-4) The elastic member 70 and the electrolyte-solution retaining sheet 73 contain capsules of the fire-prevention agent 74. For example, the capsules hermetically seal the fire-prevention agent inside a hot-melt resin, such as polypropylene. Accordingly, when the temperature of the battery cell 1 exceeds a predetermined temperature, the fire-prevention agent 74 acts to prevent a fire inside the battery cell 1.

### Modified Examples

In the above-described embodiments, the rechargeable battery includes the two electrode bodies 10 and 11 accommodated in the two compartments 21 and 22. However, the rechargeable battery may include a single electrode body or three or more electrode bodies.

In the above-described embodiments, the single lid 40 seals the two compartments 21 and 22. However, two lids 40 may seal the two compartments 21 and 22, separately.

There may be a large number of projections 72, as shown in FIGS. 2 and 3. Alternatively, a small number of projections 72 may be provided, as shown in FIGS. 8 - 11 and 13 - 15.

In the battery cell 1 of the above-described embodiments, a partition wall insulates the two compartments 21 and 22, and the cell case 20 is formed from resin. However, when the battery cell 1 includes only one electrode body, the cell case 20 may be formed from metal.

The shapes of the projections 72 in accordance with the present disclosure are not limited to the examples described in the above embodiments. As long as the projections 72 are tapered, there is no limitation to a ratio of the cross-sectional areas between the distal end side 72a and the basal end side 72b or a ratio between the height and the diameter.

The arrangement of the projections 72 in accordance with the present disclosure is not limited to the examples described in the above embodiments, such as a matrix pattern or a uniformly spaced pattern. As long as the force F (N) is evenly distributed to the lid 40 (side wall), the projections 72 may be randomly arranged.

The number of the projections 72 in accordance with the present disclosure is not limited to the examples described in the above embodiments.

Further, there may be a sheet-shaped member that is in contact with the distal ends 72a of the projections 72 in accordance with the present disclosure.

Among the projections 72 of the elastic member 70 shown in FIG. 13, the height of the projections 72ₒᵤₜ arranged at the end parts of the close-contact portion 71 in the lateral direction X is greater than the height of the projections 72ᵢₙ arranged at the central part of the close-contact portion 71 in the lateral direction X. More than one row of projections 72ᵢₙ may be arranged on the central part of the close-contact portion 71 in the lateral direction X. Also, more than one row of projections 72ₒᵤₜ may be arranged at each end part of the close-contact portion 71 in the lateral direction X. As shown in FIG. 13, projections 72_{med} having an intermediate height may be provided in addition to the projections 72ᵢₙ and 72ₒᵤₜ. The projections 72_{med} may have different heights.

In the above-described embodiments, the battery cell 1 is a Cell-to-Pack (CTP) lithium-ion battery that may be used as a battery pack for driving vehicles or the like. However, there is no limitation to the structure, composition, or shape of the rechargeable battery in accordance with the present disclosure. The present disclosure may be applied to other types of non-aqueous electrolyte rechargeable battery. The present disclosure may be applied to an alkaline rechargeable battery, such as a nickel-metal hydride rechargeable battery.

The accompanying drawings aid understanding of the present disclosure, and do not limit the present disclosure. The drawings may not accurately depict an actual rechargeable battery and may partially omit, exaggerate, or schematically illustrate the rechargeable battery.

Numerical values, numerical ranges, compositions, and the like of the above-described embodiments are merely examples, and are not intended to limit the present disclosure. A person skilled in the art may optimize such values, ranges, compositions, and the like.

It should be apparent that the present disclosure can be implemented with additions, deletions, and modifications by those skilled in the art without departing from the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rechargeable battery, comprising:
a cell case having two opposing side walls;
an electrode body accommodated in the cell case and disposed between the two opposing side walls, the electrode body being formed by stacking a cathode plate and an anode plate with a separator arranged in between and rolling the stack; and
an elastic member disposed between the electrode body and at least one of the two opposing side walls, wherein
the elastic member includes a close-contact portion being in close contact with the electrode body, and projections projecting from the close-contact portion toward the at least one of the two opposing side walls, and
the projections are each tapered.

2. The rechargeable battery according to claim 1, wherein the projections are arranged on the close-contact portion.

3. The rechargeable battery according to claim 2, wherein the projections are arranged in a matrix pattern extending in a lateral direction and a longitudinal direction, the lateral direction being orthogonal to a projecting direction of the projections, the longitudinal direction being orthogonal to both the projecting direction and the lateral direction.

4. The rechargeable battery according to claim 2, wherein the projections each have a shape of a truncated quadrilateral pyramid.

5. The rechargeable battery according to claim 2, wherein the projections each have a shape of a truncated circular cone.

6. The rechargeable battery according to claim 3, wherein
the projections include at least one projection arranged at an end part of the close-contact portion in the lateral direction and at least one projection arranged at a central part of the close-contact portion in the lateral direction, and
a height of the at least one projection arranged at the end part of the close-contact portion in the lateral direction is greater than a height of the at least one projection arranged at the central part of the close-contact portion in the lateral direction.

7. The rechargeable battery according to claim 3, wherein
the projections include at least one projection arranged at an end part of the close-contact portion in the lateral direction and at least one projection arranged at a central part of the close-contact portion in the lateral direction, and
a cross-sectional area of the at least one projection arranged at the end part of the close-contact portion in the lateral direction is greater than a cross-sectional area of the at least one projection arranged at the central part of the close-contact portion in the lateral direction.

8. The rechargeable battery according to claim 1, wherein a change ratio of a spring constant (N/mm) of the elastic member, compressed in a thickness-wise direction, relative to a compression ratio (%) of the elastic member in an initial state decreases when the compression ratio (%) becomes greater than a predetermined value.

9. The rechargeable battery according to claim 1, wherein the elastic member is porous.

10. The rechargeable battery according to claim 9, wherein the close-contact portion of the porous elastic member includes an extension extending to a position where an electrolyte solution collects by gravity.

11. The rechargeable battery according to claim 1, wherein
the elastic member includes two elastic members respectively disposed on two opposite side surfaces of the electrode body, and
one of the two elastic members does not include the projections.

12. The rechargeable battery according to claim 1, wherein
the cell case has a shape of a flat box, and
the electrode body is flattened.

13. The rechargeable battery according to claim 1, wherein the rechargeable battery is a non-aqueous electrolyte rechargeable battery.

14. The rechargeable battery according to claim 13, wherein the rechargeable battery is a lithium-ion rechargeable battery.

15. The rechargeable battery according to claim 1, wherein the elastic member contains capsules of a fire-prevention agent.
